(19) United States
(12) Patent Application Publication
(10) Pub. No.: US 2006/0106154 A1
(43) Pub. Date: May 18, 2006

(54) Thickening agents comprising a crosslinked polymer powder

(76) Inventors: Norman Stewart Batty, Puicheric (FR); Alan John Crabtree, West Yorkshire (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/533,012

(22) PCT Filed: Oct. 30, 2003
(86) PCT No.: PCT/EP03/12062

§ 371 Date: Apr. 28, 2005

(30) Foreign Application Priority Data
Nov. 7, 2002 (EP) 02405958.6

(51) Int. Cl. C08L 33/00

(52) U.S. Cl. 524/522

(57) ABSTRACT

The present application relates to a thickening composition comprising (a) 10-50% by weight, based on the total composition (a)+(b), of a crosslinked hydrophilic water soluble or swellable liquid dispersion polymer and (b) 50-90% by weight, based on the total composition (a)+(b), of a crosslinked polymer or copolymer of an unsaturated carboxylic acid in powder form, which is especially useful for thickening printing pastes for multicolour jet-printing.

There is a growing demand for patterned pile floor coverings. The pile is normally nylon, polyester, cotton or acrylic fibre, nylon being the most widely used. One solution to the problem of producing the patterns is to use jet printing. There are various jet printing systems on the market, for example the Chromojet® series from Zimmer Maschinenbau GmbH.

They are used for printing carpets, carpet tiles, mats etc.

Air pressure is used to blow a dye paste through a jet onto the material to be printed. The opening of the jets is controlled by a computer and they can open and close up to 400 times per second, so that quite complex and individual designs can be printed. Short production runs, even individual mats, can be produced economically.

The required viscosity of the printing pastes is usually adjusted by addition of suitable thickening agents like, for example, the products of the Tanaprint® series (supplied by Sybron-Tanatex)

An ideal thickener should provide a compromise between a high rate of flow and high viscosity of the printing paste. If the pastes are thinned down too much so that the rate of flow is very high, the definition of the printed mark on the carpet is lost. If the flow rate of the paste through the jet is too slow, less paste is applied to the carpet and hence the amount of dye on the carpet is lower and the colour is weaker. It would be possible to increase the concentration of dye in the paste, but this leads to difficulties in dissolving the dye and mixing the dye solution into the stock thickening, especially for heavy shades.

Nylon (polyamide) is the most widely used fibre for floor coverings. Nylon is printed with some sort of acid dye—either levelling, milling or pre-metallised—or reactive dye. The dyes all fix better the lower the pH. Pre-metallised dyes can be fixed at fairly high pH, for example ˜5.5-6, but levelling types are much better at lower pH, ideally down to pH 4.5. The Eriofast® range of dyes gives exceptional wet fastness properties but requires a pH of 4.5 or below for adequate fixation, particularly with heavy shades.

Commercial thickeners used in the multicolour printing process, like Tanaprint® ST160, consist of poly(acrylic acid) or poly(methacrylic acid) which is partially or completely neutralised with ammonia. When the thick pasty composition is stirred into water, the water thickens giving a paste of ˜pH7.5.

The dye or dyes is/are dissolved in water and mixed with the stock thickening. As the dyes contain some electrolyte and as synthetic thickeners are very sensitive to electrolyte, the viscosity of the paste usually drops to some extent. A solution of citric acid is then added to reduce the pH and to reduce the viscosity at the same time. The citric acid is added until the viscosity is suitable for printing—usually about 1400 cP (Brookfield, RV4, 20 rpm) or 300 dPa·s (Haake). The limit is about pH 5.2. Without any dye, a stock thickening of 16 g/kg of thickener based on neutralised poly(acrylic acid) can be thinned down with citric acid and will have a viscosity of ˜1400 cP at pH 5.2. Obviously, if there is any dye in the paste at all, it will reduce the viscosity even more because of the electrolyte. For heavy shades, more dye is necessary and hence there is more electrolyte and the thinning effect will be stronger. The viscosity of 1400 cP will then only be achieved by keeping the pH higher—above pH 5.5 or even 6.

Acid and reactive dyes for nylon and/or wool are fixed to the fibre in low pH conditions. The lower the pH, the more quickly and more completely the dye is fixed. Inadequate fixation leads to cross-staining when the carpet is washed. Unfixed dye from a printed area can stain adjacent areas that are not printed (i.e. left white) or printed in a different colour. Unfixed dye that gets washed off the carpet presents additional effluent treatment processes. For printing with premetallised and acid milling dyes, printing at pH 5.5 is not normally too much of a problem, although a lower pH would be better for heavy shades.

However for acid levelling dyes and dyes such as the Eriofast range, the pH should be below pH 5, preferably around pH 4.5. This applies in particular to heavy shades, and most particularly to deep reds and blacks.

The problems with the available commercial thickeners based on poly(ammonium acrylate) are:
they cannot be used below pH 5. With many dyes, particularly in heavy shades, this leads to incomplete fixation of the dye and to staining of adjacent areas in the printed carpet etc.;
the original stock thickening is very thick and it is difficult to stir the dissolved dye into it to get a homogeneous paste;
because the stock thickening is so thick, air that is inevitably drawn in during mixing, stays in the paste. If the air bubbles are not removed before printing, they will interrupt the flow of the paste through the jets and lead to white or pale spots or areas that should be coloured.
pastes made with thickeners based on poly(ammonium acrylate) tend to foam very easily. This of course depends on the type of stirrer and the stirring technique used, but it is almost always necessary to add an antifoam.

It has now surprisingly been found that a printing system with excellent properties can be made by mixing together a liquid dispersion (LDP) polymer of the type commonly used for screen printing and a powder-form crosslinked polyacrylic acid.

Using the crosslinked polyacrylic acid on its own is difficult because powders are difficult to handle—they give rise to a lot of dust, making the workplace environment very unpleasant or even dangerous; the powders take a long time to disperse in water; the powder tends to form clumps on contact with water so that, although the original particle size may be very small, the particles stick together and the wet polymer on the outside of the lumps gels and makes a very effective barrier to prevent the water from reaching the polymer inside the lumps. Even after the powder has been dispersed, a base has to be added to increase the pH before the polymer thickens the paste.

Dispersions of the powders are available but they generally have very low contents of active material, 20% or less, so that much larger amounts are needed to thicken a printing paste.

LDPs on their own are very poor thickeners below pH 5.5. In addition, effective LDP thickeners cannot be made with the required shear thinning properties so that printing pastes that are viscous enough that the sharpness of the print is acceptable, do not flow through the jets at an acceptable rate. The shear thinning behaviour can be controlled, for example, by changing the amount of crosslinking in the polymer; the less crosslinked the polymer the greater the shear thinning. However, the degree of crosslinking needed to get the necessary degree of shear thinning is so low that the resulting pastes become very viscoeleastic and stringy. When the jet is closed, the stream of polymer does not break off cleanly—it forms threads of paste between the jet and the printed fabric. These threads may be several millimetres long and give rise to unacceptable lines on the print

However, the inventors have found that by combining a powder thickener with an LDP these problems can be overcome.

Accordingly, the invention relates to a thickening composition comprising
(a) 10-50% by weight, based on the total composition (a)+(b), of a crosslinked hydrophilic water soluble or swellable liquid dispersion polymer and
(b) 50-90% by weight, based on the total composition (a)+(b), of a crosslinked polymer or copolymer of an unsaturated carboxylic acid in powder form.

The term “liquid dispersion polymer” is understood to mean a polymer that is made by Inverse phase polymerisation of an aqueous solution of one or more water soluble monomers, the monomer solution being finely dispersed as an emulsion in a solvent that is not miscible with water. After polymerisation, the water is removed from the polymer dispersion in a separate step. Such a process is described, for example, in U.S. Pat. Nos. 4,059,552 and 3,284,393 and in EP-A 0 161 038.

The hydrophilic, water soluble or swellable liquid dispersion polymers employed in the present invention may be either anionic or cationic. Said polymers may be homopolymers or copolymers. They are formed from one or more monoethylenically unsaturated monomers that are either water soluble anionic or cationic monomers or from a predominantly anionic or cationic blend of monomers that may consist of anionic and cationic monomers or may consist of a mixture of anionic and/or cationic monomers and a minor amount of nonionic monomers.

The polymers may conveniently be obtained in the form of microparticles having an average particle size in the range of 0.1-2 microns by reverse phase emulsion polymerisation of suitable monomers in a hydrophobic liquid, i.e. a liquid which has sufficiently low miscibility with water that it can be used as the non-aqueous phase in a reverse phase polymerisation. The liquid must have substantially no solvating effect for the polymer, or for the monomers from which it is formed, throughout the range of temperatures at which the polymer is likely to be synthesised (for instance from 15 to 100° C.), since a solvating medium would be unsatisfactory for reverse phase emulsion polymerisation. Likewise, the monomer or monomer blend must be water soluble to enable reverse phase polymerisation to be carried out.

Suitable cationic monomers include diallyl dialkyl monomers such as diallyl dimethyl ammonium chloride, but preferably the cationic monomer is a dialkylaminoalkyl (meth)acrylate or -acrylamide. Although the polymer can be in free base form, especially when it is a cationic acrylamide or methacrylamide, it is preferably in the form of an acid addition or quaternary ammonium salt.

When the monomer is a cationic acrylamide or methacrylamide, the dialkylaminoalkyl group is generally a dialkylamino propyl or dialkylamino isopropyl group. When the monomer is a cationic acrylate or methacrylate, the dialkylaminoalkyl group is generally a dialkylaminoethyl group.

Preferably, component (a) is an anionic polymer.

Suitable anionic monomers include unsaturated carboxylic acids such as acrylic acid, methacrylic acid and their alkali metal and ammonium salts, maleic acid, fumaric acid, crotonoic acid, sorbic acid, itaconic acid, 3-acryloxypropionic acid and their salts, sodium styrene carboxylate 2-acrylamido-2-methyl propane sulphonic acid (AMPS) and its alkali metal or ammonium salts and the like. Mixtures of such monomers may also be used.

Acrylic acid and methacrylic acid are the most preferred anionic monomers.

Preferably the carboxylic acid groups are at least 50%, advantageously 55-90%, in particular 60-70%, in the form of an alkali metal salt or ammonium salt, especially the ammonium salt.

Suitable nonionic monomers include acrylamide, methacrylamide, N-vinyl pyrrolidone and water soluble hydroxy-substituted acrylic or methacrylic esters.

If a cationic blend is used, the amount of cationic monomer is preferably more than 50% by weight of the blend, and usually it is at least 70% or at least 80% by weight of the blend. The preferred cationic polymers are formed wholly from cationic monomers.

If an anionic blend is used, the amount of anionic monomer is preferably more than 60% by weight of the blend, and usually it is at least 80% by weight of the blend. The preferred anionic polymers are formed wholly from anionic monomers.

The liquid dispersion polymer compositions are advantageously crosslinked by incorporating a small amount of a suitable crosslinking agent such as a polyfunctional vinyl addition monomer into the polymerisation mixture. Preferably a water soluble crosslinking agent is used.

Any of the conventional polyethylenically unsaturated cross linking agents which are soluble in the monomer or monomer blend can be used, including materials which are di-, tri- or tetraethylenically unsaturated, such as divinyl benzene, allyl acrylates and methacrylates, glycol diacrylates and dimethacrylates, 1,7-octadiene, triallylcyanurate or -isocyanurate, allyl acrylamide or allyl methacrylamide, di- tri- or tetraallyl quaternary ammonium salts, methylene bisacrylamide, methylene bismethacrylamide, vinyloxyethyl acrylate or methacrylate and polyallyl ethers of polyols, such as polyallyl sucrose, polyallyl pentaerythritol and diallyl glycols.

Preferred are diethylenically unsaturated compounds such as methylene bis-acrylamide, triallyl methyl ammonium chloride, tetraallyl ammonium chloride, polyethylene glycol di(meth) acrylate, vinyloxyethylacrylate or -methacrylate and the like. Methylene bis-acrylamide is the most preferred crosslinking agent.

The amount of cross linking agent is generally in the range from 10 to 10,000 parts by weight of cross linking agent per million parts (by dry weight) of monomer. Most preferably it is around 50 to 2000 ppm, especially 100 to 1500 ppm for either cationic or anionic monomers. Optimum amounts can be determined by routine experimentation.

Component (a) is advantageously applied in form of a dispersion in a hydrophobic liquid.

The powder thickener, component (b), is preferably made by precipitation polymerisaton. A monomer, such as acrylic acid, is dissolved in a solvent that is chosen such that it is a solvent for the monomer but not for the polymer. When polymerisation of the monomer is initiated, the polymer precipitates from the solution as it forms and after the polymerisation is complete can readily be separated from the solvent. The polymer is collected in the form of a fine powder.

The polymers in powder form according to component (b) are the crosslinked polymers and copolymers of unsaturated carboxylic acids conventionally used in this technical field, such as acrylic, methacrylic, crotonic, sorbic, itaconic, maleic, fumaric and 3-acryloxypropionic acid. In the case of copolymers, these contain at least 70% by weight of the above cited unsaturated acids. Possible comonomers are, for example the esters of the above cited unsaturated acids with alcohols containing, 1 to 30 carbon atoms or with alcohols or phenols polyethoxylated and/or polypropoxylated, hydroxyalkyl acrylates or methacrylates, alkoxyalkyl acrylates or methacrylates, acrylonitrile, methacrylonitrile, acrylamide or methacryamide and N-substituted derivatives thereof, vinyl alcohol esters, vinyl ethers, ethylene, propylene, styrene and butadiene monomers.

Preferably, component (b) is a crosslinked poly(acrylic acid) or a crosslinked poly(methacrylic acid).

These carboxylic polymers are are preferably crosslinked with polyunsaturated compounds such as divinyl benzene, allyl acrylates and methacrylates, polyethylene glycol diacrylates and dimethacrylates, 1,7-octadiene, butadiene, triallylcyanurate, or isocyanurate, allyl acrylamide or allyl methacrylamide, methylene bisacrylamide and polyallyl ethers of polyols, such as polyallyl sucrose, polyallyl pentaerythritol and diallyl glycols.

The amount of cross linking agent is generally in the range from 10 to 10,000 parts by weight of cross linking agent per million parts (by dry weight) of monomer. Most preferably it is around 50 to 2000 ppm, especially 100 to 1500 ppm for either cationic or anionic monomers. Optimum amounts can be determined by routine experimentation.

The carboxylic polymers according to component (b) can be obtained with techniques of precipitation or dispersion polymerization from solvents such as benzene, methylene chloride, aliphatic and/or aromatic hydrocarbons, esters, ethers, ketones and mixtures thereof.

The thickener compositions according to the invention can be prepared by any suitable method known to those of ordinary skill in the art. For example, the components of the composition and, where appropriate, further additives can be combined and mixed in a suitable mixer or blender.

Purposively, components (a) and (b) are mixed in a hydrophobic liquid, optionally in the presence of one or more wetting or dispersing agents.

Accordingly, a further object of the invention is a composition containing components (a) and (b), as defined above, and additionally (c) a hydrophobic liquid.

Suitable inert hydrophobic liquids include hydrocarbons, halogenated hydrocarbons and esters, such as 2-ethylhexyl palmitate and triolein.

Preferred hydrophobic liquids are mineral oils and paraffin oils.

The hydrophobic liquid may be the same as that used in preparation of the LDP (component (a)) or different.

The amount of component (c) is preferably 40 to 80% by weight, in particular 50 to 70% by weight, based on the total composition (a)+(b)+(c).

The composition may also optionally include other components, such as antifoams, antifrosting agents, biocides, acids or bases to give any required pH in the printing paste, surfactants to improve the dispersion of the product when it is stirred in water, stabilisers to improve the storage stability of the product etc.

In a further preferred embodiment, the composition according to the invention contains fumed silica as stabilizer.

The amount of fumed silica is preferably in the range of 0.5-20.0% by weight, in particular 1-10% by weight, based on the sum of the amounts of components (a)+(b).

A further obect of the invention is a printing paste prepared by using a thickening composition as described above.

The printing paste will normally comprise at least one dye. However, when the design includes a white area, it is often advantageous to print a blank paste, -i.e. a paste with no dye, in this area. This helps to prevent dye bleeding from adjacent coloured areas into the white. To improve this effect even further, the blank paste may comprise a so-called reserving agent. Reserving agents are colourless or virtually colourless chemicals with structural resemblances to the dyes. They block available dye sites in the fibre, particularly at the surface of the fibre, so that these sites are not available for the dyes.

Preferably, the printing pastes contain at least one dye.

Further components which may be present in the printing pastes are e.g. additional natural or synthetic thickeners, pigments, acids, bases and/or salts to adjust the pH to the desired value, anionic, nonionic or cationic surfactants, antifoaming and antifrosting agents, dispersing agents, fixing agents, polyhydroxy compounds, reaction products of hydroxyl compounds and isocyanates, polyesters prepared by reaction of terephthalic acid and one or more polyethylene glycols. These components are commonly used or recommended for textile printing or finishing.

Preferably, the pastes may also be made up with reserving agents, as described above, and/or agents to protect against the action of chlorine.

The printing pastes according to the invention can be applied in conventional manner using conventional equipment.

Preferably, however, a multicolour jet-printing process is used for printing textile material made of natural or synthetic polyamide, like nylon, perlon, silk or wool, viscose rayon or cotton, but most preferably nylon, wool or wool/nylon blends.

The multicolour jet-printing process using the Chromojet® equipment from Zimmer Maschinenbau GmbH has been preferably applied for the printing of carpets. Chromojet printing works by injecting colors into the pile of the carpet through a valve and nozzle system to create the pattern established by the design system.

Therefore, a preferred embodiment of the invention is a process for the multicolour jet-printing of textile materials characterised in that the material is printed with an aqueous printing paste containing dyes and a thickening composition as decribed above.

The pH of the aqueous printing paste is preferably ≦5.

By adjusting the ratio of components (a) and (b) and also by adjusting the degree of neutralisation of the polymer in component (a), the pH of the resulting paste can be set to any value between about pH 3.5 (90% powder) and pH 6. Thus, a system can be prepared in which the thickener is stirred into water and gives a paste with a pH of −4.4. This is ideal for printing with levelling acid dyes or Eriofast dyes. If a higher pH is required, caustic can be added as required. This increases the pH and makes the thickener more economical. The LDP provides a reasonable stabilising system for the powder, which tends towards settling out when it is dispersed in oil alone.

The invention provides several technical advantages:
the printing process can be carried out at low pH, down to about pH 4.5;
make up is easier—dye can be added to a thin paste at pH 4.5 and stirs in easily;

the air that inevitably gets stirred in can escape easily. If desired, the pH can then be brought up and the paste thickened to the required viscosity with caustic. This is easier than trying to stir dye into a thick paste at pH 7 and then thinning with citric acid;
additional antifoams are normally not required.

The following non-limitative Examples illustrate the invention in more detail. Parts and percentages are by weight, unless otherwise stated. In the Examples the following components are applied:
LDP1: liquid dispersion polymer, prepared by inverse emulsion polymerisation of acrylic acid, partially neutralized with ammonia, in the presence of 250 ppm of a crosslinking diethylenically unsaturated monomer like methylene bisacrylamide and azeotropic distillation, giving a dispersion in mineral oil (about 60% by weight of polymer with about 35% free acid groups and about 65% COONH₄-groups, about 36% by weight of mineral oil, with 2% of a water-in-oil emulsifying agent and about 2% residual water)
LDP2: a liquid dispersion polymer prepared by inverse emulsion polymerisation of acrylic acid, partially neutralized with sodium, with a crosslinking monomer, in a mineral oil (about 60% by weight of polymer, about 36% by weight of mineral oil, with 2% of a water-in-oil emulsifying agent and about 2% residual water)
CLPA1: crosslinked polyacrylic acid made by precipitation polymerisation of acrylic acid in an organic solvent in the presence of 100 ppm of a crosslinking diethylenically unsaturated monomer like methylene bisacrylamide, and subsequent removal of the solvent to give a dry powder of polyacrylic acid (5 g/kg in water, fully neutralised with ammonia, gives a viscosity of ˜30 Pa·s (˜30000 cP))
Tanaprint® EP2300 commercial thickener, dispersion of poly(ammonium acrylate) (supplied by Bayer)
Tanaprint® ST160 commercial thickener (supplied by Bayer)
Solvent Neutral 150: solvent refined paraffin oil, pour point: ˜−12° C., viscosity @40° C.: ˜3-105 m²/s (˜30 cSt)
Isopar® L mixture of isoparaffins (supplied by Exxon Mobil Corporation), viscosity at 25° C.: 1.26 mPa·s
Exxsol® D100 mixture of aliphatic and cycloaliphatic hydrocarbons with a boiling range of ˜235 to 270° C.
Estol® 1543 2-ethylhexyl palmitate (supplied by Uniqema)
Dowfax® EM 51: dispersing agent, fatty alcohol ethoxylated (supplied by Dow)
Tanasperse® CJ anionic dispersing agent (supplied by Bayer)
Irgapadol® PN New antifrosting agent (supplied by Ciba Specialty Chemicals)
Nofome® antifoam agent (supplied by Bayer)
Acticide® 45 biocide (supplied by Thor Chemie GmbH)
Aerosil® 200 fumed silica (supplied by Degussa)
Aerosil® 380 fumed silica (supplied by Degussa)
Eriofast® Blue 3R anthraquinone dye (supplied by Ciba Specialty Chemicals)
Eriofast® Red 2B azo dye (supplied by Ciba Specialty Chemicals)
Eriofast Yellow® R azo dye (supplied by Ciba Specialty Chemicals)
Tectilon® Red 2B 200 azo dye (supplied by Ciba Specialty Chemicals)
Tectilon® Yellow 3R 200 azo dye (supplied by Ciba Specialty Chemicals)
Tectilon® Blue 4R 200 anthraquinone dye (supplied by Ciba Specialty Chemicals)
Polar® Yellow 4G azo dye (supplied by Ciba Specialty Chemicals)
Lanaset® Yellow 2R metal complex dye (supplied by Ciba Specialty Chemicals)
Lanaset® Grey 2R metal complex dye (supplied by Ciba Specialty Chemicals)

### EXAMPLE 1

40 g LDP1, 108 g Solvent Neutral 150 and 2 g Dowfax® EM51 are stirred together in a 250 ml plastic beaker with a stirrer with a saw-tooth head. 50 g CLPA1 is added in portions of about 5 g at a time and stirred in after each addition. The mixture is stirred at ˜2000 rpm for 2 minutes after the final addition. The resulting mixture is a stable dispersion with a Brookfield RVT viscosity of 1.2 Pa·s (1200 cP) at 20 rpm, 25° C.

### EXAMPLE 2

3.96 kg of water is stirred with 8.0 g of Eriofast® Blue 3R, 0.80 g of Eriofast® Red 2B and 0.80 g of Eriofast® Yellow R and 44 g of the thickener from Example 1.

The viscosity according to Haake is 0.18 Pa·s (180 cP), pH 4.47. As the viscosity is low, mixing is very easy and no air is trapped in the paste.

0.5 ml of 50% caustic soda is added to get a printing viscosity of 310 cP and pH 4.80.

A comparison is made with the same concentrations of dyes, 9.67 g/kg of Tanaprint® EP2300, 1.00 g/kg Irgapadol® PN New, 2.00 g/kg Nofome® and 2.00 g/kg Tanasperse® CJ.

The viscosity is 0.38 Pa·s (380 cP), pH 6.0. This is cut back with citric acid/water (1:2) to 0.31 Pa·s (310 cP).

The pastes are compared for flow rate through the jets of a Chromojet MP at 2.4 bar for 20 seconds.

Comparative paste: 125 g of paste

Paste of Example 1: 122 g of paste. There is virtually no difference in the amount of paste delivered.

The pastes are printed onto a rubber-backed mat with a nylon pile. After printing, the mat is steamed in a Werner-Mathis steamer at 100° C., 100% humidity for 5 minutes and then washed off with a stream of water and dried at about 50° C. The paste of Example 1 gives a slightly better colour yield than the comparative paste. Penetration of the paste into the pile of the mat and the levelness of the prints are very similar. There is little or no frosting in either case.

The benefits of ease of make up, no problems with air becoming trapped in the paste and the lower pH are apparent.

### EXAMPLE 3

Pastes are made up with 3 g/l Eriofast Red 2B thickened to 1400 cP (Brookfield RVT, #4, 20 rpm) with Tanaprint® ST160 and with the thickener of Example 1.

(Comparative paste: pH 5.5; paste of the invention: pH 4.9).

The pastes are printed onto nylon carpet on a Chromojet sample machine. The carpet is steamed for 5 minutes in saturated steam at 100° C. It is washed off with a spray of cold water. All the dye Is fixed on the print of the invention. Dye can be seen being washed out of the comparative print. The adjacent white ground is stained significantly.

The advantage of being able to print at a low pH is demonstrated. The low pH is essential for adequate fixation with Eriofast dyes.

### EXAMPLE 4

A thickener is made by stirring 160 g of LDP2, 250 g of Isopar® L, 250 g of Solvent Neutral 150 and 20 g of Dowfax® EM 51. 320 g of CLPA1 is added in portions of about 20 g and the mixture stirred after each addition until the powder is mixed into the liquid. After all the CLPA1 has been added, the mixture is stirred with a high speed stirrer for 20 minutes.

The resulting dispersion has a viscosity (Brookfield RVT, spindle #4, 20 rpm) of 1200 cP and a pH in water (9 g/kg) of 4.63.

### EXAMPLE 5

A green dye solution is made with 10.00 g of Tectilon® Yellow 3R200, 10.00 g of Tectilon® Blue 4R 200 dissolved in boiling water and diluted to 1000 g.

A printing paste is made by stirring 9.27 g of the thickener of Example 4 into 890.7 g of water until it makes a smooth paste and then stirring in 100 g of the dye solution.

This paste has a viscosity of 1460 cP (Brookfield RVT, spindle #4, 20 rpm) and a pH of 4.61. It iss printed onto nylon-6,6 cut pile carpet on a Chromojet sample machine. The carpet is steamed for 5 minutes in saturated steam at 100° C. and then washed off with a spray of cold water. All the dye is fixed (no colour Iss observed in the washing water and there is no staining of the adjacent white). The penetration of the dye into the pile and the sharpness of the outline are both excellent.

### EXAMPLE 6

97 kg of water is weighed into a drum. 1.25 kg of the thickener of Example 1 is added and high speed stirring started. After 10 minutes, the paste is smooth and homogeneous. The viscosity is 750 dPa·s (Haake). 150 g of Irgapadol® PN New is added and then 45 g of Polar® Yellow G, 100 g of Lanaset® Yellow 2R and 26 g of Lanaset® Grey G are dissolved in 1 litre of hot water and added to the paste. Because of the low viscosity of the paste, the colour mixes in easily and quickly becomes evenly distributed. The viscosity is 220 dPa·s.

It is printed onto a high twist, cut pile rubber backed rug on a 2 m wide Chromojet F machine, at a pressure of 1.8 bar and a head speed of 940.

The rug is steamed for 7 minutes in saturated steam at 100° C. and then washed with a spray of cold water. No colour is seen in the wash water and there is no staining of adjacent white areas. Excess water is sucked from the rug and then it is tumble dried.

The colour is bright, the penetration is down to the root of the pile, there is no frosting and the edges of the printed marks are sharp.

### EXAMPLE 7

422.4 g of LDP2, 991.0 g of Exxsol D100, 991.0 g of Solvent Neutral 150, 32.0 g of Dowfax® EM51 and 0.06 g of Acticide® 45 are stirred together and 64.0 g of Aerosil® 200 is added, and 705 g of CLPA1 is added in portions and mixed in after each addition.

The viscosity is low (˜2500 cP, Brookfield RV5, 20 rpm) at first, but thickens up on standing for a few hours. The product becomes very thixotropic—the viscosity is enough to prevent any settlement of the suspended material, but thinns down so that it can be used easily after very gently stirring. No settlement of the suspended material is observed after two months' storage.

A solution of 2 g/kg Tectilon Red 2B200 is thickened to 1400 cP (Brookfield RV5, 20 rpm) with 11.17 g/kg of this thickener. The pH of the paste is 4.74.

It is printed onto nylon-6,6 cut pile carpet on a Chromojet sample machine at a pressure of 1.8 bar. The carpet is steamed for 5 minutes in saturated steam at 100° C. and then washed off with a spray of cold water. All the dye is fixed (no colour is observed in the washing water and there is no staining of the adjacent white). The penetration of the dye into the pile and the sharpness of the outline are both excellent.

### EXAMPLE 8

(Using a biodegradable ester instead of mineral oil as the carrier medium)

144.1 g of LDP2, 780.0 g of Estol® 1543, 12.46 g of Dowfax® EM51, 0.02 g of Acticide® 45 are stirred together and 24.0 g of Aerosil® 380 is added, followed by 240 g of CLPA1 is added in portions and mixed in after each addition.

The product is very thixotropic—it isthick enough to prevent any settlement of the suspended material, but thinns down to be easily usable with very gently stirring. No settlement of the suspended material was observed after two months' storage.

A solution of 2 g/kg Tectilon Red 2B200 is thickened to 1400 cP (Brookfield RV5, 20 rpm) with 12.63 g/kg of this thickener. The pH of the paste is 4.75.

It is printed onto nylon-6,6 cut pile carpet on a Chromojet sample machine at a pressure of 1.8 bar. The carpet is steamed for 5 minutes in saturated steam at 100° C. and then washed off with a spray of cold water. All the dye is fixed (no colour is observed in the washing water and there is no staining of the adjacent white). The penetration of the dye into the pile and the sharpness of the outline are both excellent.

1. A thickening composition comprising:
(a) 10-50% by weight, based on the total composition (a)+(b), of a crosslinked hydrophilic water soluble or swellable liquid dispersion polymer and
(b) 50-90% by weight, based on the total composition (a)+(b), of a crosslinked polymer or copolymer of an unsaturated carboxylic acid in powder form.

2. A composition according to claim 1 wherein component (a) is an anionic polymer.

3. A composition according to claim 2 wherein the anionic polymer is the polymer of an unsaturated carboxylic acid.

4. A composition according to claim 3 wherein the anionic polymer is poly(acrylic acid) or poly(methacrylic acid).

5. A composition according to claim 3 containing the polymer of an unsaturated carboxylic acid wherein 55-90% of the carboxylic acid groups are in the form of an alkali metal salt or ammonium salt.

6. A composition according to claim 1 wherein component (b) is made by precipitation polymerization.

7. A composition according to claim 1 wherein component (b) is a crosslinked poly(acrylic acid) or a crosslinked poly(methacrylic acid).

8. A composition according to claim 1 containing additionally (c) a hydrophobic liquid.

9. A composition according to claim 8 containing mineral oil or paraffin oil as component (c).

10. A composition according to claim 8 containing 40 to 80% by weight of component (c), based on the total composition (a)+(b)+(c).

11. A printing paste comprising a thickening composition according to claim 1.

12. A printing paste according to claim 11 containing at least one dye.

13. A printing paste according to claim 11 containing at least one reserving agent.

14. A printing paste according to claim 11 containing at least one agent to protect the print against the action of chlorine.

15. A process for the multicolour jet-printing of textile materials, wherein the material is printed with an aqueous printing paste containing dyes and a thickening composition according to claim 1.

16. A process according to claim 15, wherein the pH of the aqueous printing paste is ≦5.

17. A printing paste according to claim 12 containing at least one reserving agent.

18. A printing paste according to claim 12 containing at least one agent to protect the print against the action of chlorine.

19. A printing paste according to claim 13 containing at least one agent to protect the print against the action of chlorine.
